(19) United States
(12) Patent Application Publication
(10) Pub. No.: US 2025/0168766 A1
(43) Pub. Date: May 22, 2025

(54) APPARATUS AND METHOD FOR ENERGY SAVING IN WIRELESS COMMUNICATION SYSTEM

(71) Applicant: ELECTRONICS AND TELECOMMUNICATIONS RESEARCH INSTITUTE, Daejeon (KR)

(72) Inventors: Tae Jung KIM, Daejeon (KR); Jee Hyeon NA, Daejeon (KR); Jung Mo MOON, Daejeon (KR)

(73) Assignee: ELECTRONICS AND TELECOMMUNICATIONS RESEARCH INSTITUTE, Daejeon (KR)

(21) Appl. No.: 18/953,472

(22) Filed: Nov. 20, 2024

(30) Foreign Application Priority Data
Nov. 21, 2023 (KR) 10-2023-0162430

(51) Int. Cl. H04W 52/02

(52) U.S. Cl. CPC H04W 52/0206

(57) ABSTRACT

Proposed are a method performed by an apparatus related to a self-organizing network (SON) in a wireless communication system, and an apparatus supporting the same. Proposed are a method performed by a first apparatus in a wireless communication system, and an apparatus supporting the same. The method may include receiving the number of RRC connections from a first base station, determining whether the number of RRC connections exceeds a threshold value for energy saving, obtaining information on a second base station neighboring the first base station on the basis of the fact that the number of RRC connections does not exceed the threshold value, and determining an energy saving base station on the basis of current physical resource block usage (PRBU) and predicted PRBU of the second base station.

### TECHNOLOGY FIELD

The present disclosure relates generally to a wireless communication system. More particularly, the present disclosure relates to an apparatus and a method for energy saving in a wireless communication system.

### BACKGROUND OF THE DISCLOSURE

Recently, the advent of the 5G mobile communication era has increased the demand for remote robot control, autonomous vehicle driving, drone control, an unnamed aerial vehicle (UAV), and augmented reality (AR)/virtual reality (VR) services requiring a large amount of data.

The development of various user equipments and the exponential growth of services based on a large amount of content have led to a significant increase in the traffic that base stations need to deal with, resulting in an exponential increase in base station establishment.

Most of the power consumption of base stations, which increase exponentially, occurs in a wireless network system, and there is a need for an energy saving technology that satisfies efficient cost and services between operators and customers.

Therefore, the present disclosure proposes an energy saving technology for an intelligent base station, and a system therefor.

### CONTENT OF THE INVENTION

### The Object of the Invention

The present disclosure is directed to providing an apparatus and a method for energy saving in a wireless communication system.

### Technical Object of the Invention

According to various embodiments of the present disclosure, there is provided a method performed by an apparatus related to a self-organizing network (SON) in a wireless communication system. There are provided a method performed by a first apparatus in a wireless communication system, and an apparatus supporting the same. The method includes: receiving the number of RRC connections from a first base station; determining whether the number of RRC connections exceeds a threshold value for energy saving; obtaining, on the basis of the fact that the number of RRC connections does not exceed the threshold value, information on a second base station neighboring the first base station; and determining an energy saving base station on the basis of current physical resource block usage (PRBU) and predicted PRBU of the second base station.

According to various embodiments of the present disclosure, there is provided an apparatus related to a self-organizing network (SON) in a wireless communication system. The apparatus may include at least one transceiver, and at least one processor connected to the at least one transceiver. The at least one processor may enable the apparatus to: receive the number of RRC connections from a first base station; determine whether the number of RRC connections exceeds a threshold value for energy saving; obtain, on the basis of the fact that the number of RRC connections does not exceed the threshold value, information on a second base station neighboring the first base station; and determine an energy saving base station on the basis of current physical resource block usage (PRBU) and predicted PRBU of the second base station.

### Effect of the Invention

The apparatus and the method according to various embodiments of the present disclosure can save energy by controlling the power of a base station.

The apparatus and the method according to various embodiments of the present disclosure can minimize operating costs and power consumption costs through control of the power of a base station.

The apparatus and the method according to various embodiments of the present disclosure can guarantee the quality of service (QoS) of a user equipment (user) relative to power efficiency as much as possible.

Effects that may be obtained from the present disclosure will not be limited to only the above described effects. In addition, other effects which are not described herein will become apparent to those skilled in the art from the following description.

### BRIEF DESCRIPTION OF THE DRAWINGS

FIG. 1 shows a scenario for saving the energy of a base station in a wireless communication system according to various embodiments of the present disclosure.

FIG. 2 shows a base station operation system for energy saving in a wireless communication system according to various embodiments of the present disclosure.

FIG. 3 shows what collects data from a base station related to a SON system and what is collected in a wireless communication system according to various embodiments of the present disclosure.

FIG. 4 shows an energy saving base station determination part in a wireless communication system according to various embodiments of the present disclosure.

FIG. 5 shows a CIO determination part in a wireless communication system according to various embodiments of the present disclosure.

FIG. 6 shows a procedure for deactivating an ES target base station on the basis of a traffic threshold value in a wireless communication system according to various embodiments of the present disclosure.

FIG. 7 shows an energy saving operation procedure in a wireless communication system according to various embodiments of the present disclosure.

FIG. 8 shows a method in which an apparatus related to a self-organizing network (SON) performs wireless communication according to an embodiment of the present disclosure.

FIG. 9 shows a configuration diagram of a base station in a wireless communication system according to various embodiments of the present disclosure.

FIG. 10 shows a configuration diagram of a user equipment in a wireless communication system according to various embodiments of the present disclosure.

FIG. 11 shows a configuration diagram of a SON system in a wireless communication system according to various embodiments of the present disclosure.

### DETAILED DESCRIPTION OF THE EMBODIMENTS

The terms used in the present disclosure are merely used to describe a particular embodiment, and are not intended to limit the scope of another embodiment. An expression used in the singular encompasses the expression of the plural, unless it has a clearly different meaning in the context. All the terms including technical and scientific terms used herein have the same meaning as commonly understood by those skilled in the art to which the present disclosure belongs. Among the terms used in the present disclosure, the terms defined in a general dictionary may be interpreted to have the meanings the same as or similar to the contextual meanings in the relevant art, and are not to be interpreted to have ideal or excessively formal meanings unless explicitly defined in the present disclosure. In some cases, even the terms defined in the present disclosure should not be interpreted to exclude the embodiments of the present disclosure.

In various embodiments of the present disclosure to be described below, a hardware approach will be described as an example. However, the various embodiments of the present disclosure include a technology using both hardware and software, so the various embodiments of the present disclosure do not exclude a software-based approach.

In addition, in the detailed description and claims of the present disclosure, the expression “at least one of A, B, and C” mean “only A”, “only B”, “only C”, or “any combination of A, B, and C”. In addition, the expression “at least one of A, B, or C” or “at least one of A, B, and/or C” may mean “at least one of A, B, and C”.

The present disclosure proposes a method for effective energy saving while guaranteeing the quality of a service that a customer uses as much as possible.

Hereinafter, the present disclosure relates to an apparatus and a method for energy saving in a wireless communication system. Specifically, the present disclosure describes a technology for controlling the power of a base station in a wireless communication system.

The terms referring to signals, the terms referring to channels, the terms referring to control information, the terms referring to network entities, the terms referring to elements of an apparatus, and the like used in the description below are only examples for the convenience of description. Accordingly, the present disclosure is not limited to the terms described below, and the terms may be replaced by other terms having the same technical meanings.

In addition, various embodiments of the present disclosure are described using terms used in some communication standards (e.g., the 3rd Generation Partnership Project (3GPP)), but the embodiments are only examples for the description. The various embodiments of the present disclosure may be easily modified and applied to other communication systems.

The present disclosure relates to a technology that controls the power of a mobile communication base station to save the energy of the base station during the time when the base station is not used frequently.

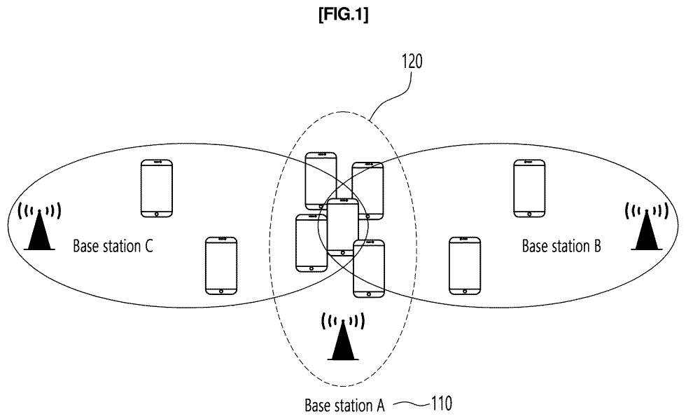

FIG. 1 shows a scenario for saving the energy of a base station in a wireless communication system according to various embodiments of the present disclosure. The configuration of FIG. 1 may be combined with various embodiments of the present disclosure.

Referring to FIG. 1, base station A 110 may serve as a booster base station in preparation for the case in which base station traffic increases significantly in particular situations, such as demonstrations, sports games, traffic jams, and university shopping districts, in the area where base station B and C operate. The base station A 110, which is the booster base station, is only needed in particular situations or times, effectively controlling the power of the base station A 110 may be an important factor in energy saving. A user equipment 120 may exist within the coverage of the base station A 110.

The present disclosure proposes a technology and a system that are required to operate a base station that is an energy saving target, such as the base station A 110.

FIG. 1 shows a particular scenario, but the present disclosure is not limited thereto. For example, the present disclosure may be applicable to operating scenarios other than the scenario of FIG. 1.

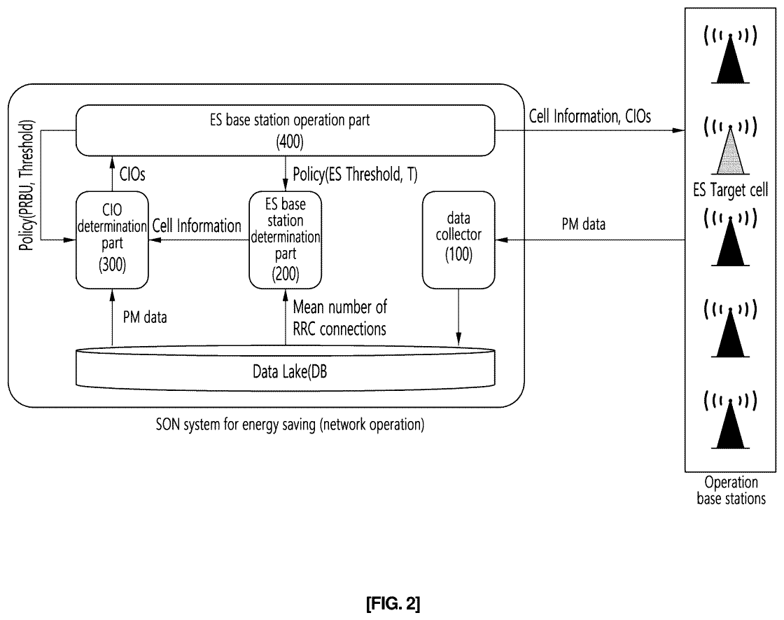

FIG. 2 shows a base station operation system for energy saving in a wireless communication system according to various embodiments of the present disclosure. The configuration of FIG. 2 may be combined with various embodiments of the present disclosure.

Referring to FIG. 2, a system that is in charge of energy saving policy and control of a base station is positioned on the network operation side of the base station. Intelligently performing network operation is called a self-organizing network (SON) system, and an energy saving operation system is positioned in the SON. Alternatively, other systems that operate the base station are included.

The system that is in charge of energy saving policy and control of a base station may be a SON system for energy saving. The SON may be a technology introduced to improve network efficiency, performance, and service quality in a wireless network. The primary goal of the SON may be to reduce operating costs and optimize network performance through automation of network management and operation. The main functions of the SON are as follows.
Self-configuration: A new network element may be automatically configured and operated when added to the network.
Self-optimization: Optimal performance is maintained by continuously adjusting network parameters according to changes in network traffic, the number of users, and RF conditions. For example, there may be handover parameter adjustment, and power control.
Self-healing: This may be a function that automatically detects a network failure when it occurs, and temporarily solves the problem or makes a full recovery.

The SON may be particularly important in wireless communication systems, such as long-term evolution (LTE), and 5G. As a network environment becomes complex and users' data usage continues to increase, automation and optimization of network management may be essential. The introduction and implementation of the SON technology may require consideration of compatibility with existing network operation methods, standardization issues between different equipment and solution providers, and the influence of automated decisions on existing network operations.

The system that is in charge of energy saving policy and control of a base station may be a system for network operation. The system that is in charge of energy saving policy and control of a base station may transmit and receive signals to and from an operating base station. For example, the system that is in charge of energy saving policy and control of a base station may transmit cell information to an operating base station. For example, the system that is in charge of energy saving policy and control of a base station may receive data from a base station. For example, the system that is in charge of energy saving policy and control of a base station may receive performance management (PM) data from a base station. The cell information may include cell individual offset (CIO). The CIO may be a measurement event parameter that is generally used by a base station for handover.

For example, the CIO may be a parameter that is used to adjust the priorities of individual cells with respect to handover determination. Handover may mean a process in which when a UE moves from one cell to another, the connection is switched to the cell. Handover determination may be generally based on the signal strength between the cell to which a user equipment is currently connected and an adjacent cell. In an actual network environment, this handover determination may need to be fine-adjusted for a variety of reasons, which may be why the CIO is needed. The CIO may add an individual offset value to a particular cell to artificially increase or decrease the priority of the cell. For example, if a cell is overloaded, the priority of the cell may be decreased by setting the CIO value to a negative number to reduce handover to the cell. The CIO may be used as an important tool for a network operator to optimize the performance of the network and improve user experience.

For example, the cell information may mean information on a particular cell in a wireless communication system. In the wireless communication system, various parameters and attributes for each cell may be included. The information on a cell may provide important data required for network operation, management, optimization, and troubleshooting. The cell information may provide key information for network design, troubleshooting, performance optimization, and operation and management tasks.

For example, the cell information may include the following data.
Cell identity (Cell ID (CI)): A unique identifier to distinguish each cell.
Location area code (LAC) or Tracking Area Code (TAC): An identifier representing a larger area for grouping multiple cells.
Physical cell ID (PCI): An identifier used to identify a cell in LTE and 5G networks.
Frequency information: Information on a frequency band and a channel in which the cell operates.
Neighboring cell list: Information on other cells adjacent to the cell. This is important in the handover process.
Transmit power: The transmission output of the cell.
Antenna setting information: Information on the direction, tilt angle, and height of an antenna.
Other operation parameters: Various operation parameters, such as transmission schedule, an access control parameter, and a transmission mode.

For example, PM data may mean various statistical or measurement values collected to monitor and manage the performance of network equipment or services. The PM data may be used to evaluate and optimize the efficiency, stability, and performance of the network. The PM data may help quickly recognize and prevent a system failure, and may be important for detecting and analyzing issues, such as changes in network traffic, and degradation of service quality.

The system that is in charge of energy saving policy and control of a base station may include a data collector 100. The system that is in charge of energy saving policy and control of a base station may include an ES base station determination part 200. The system that is in charge of energy saving policy and control of a base station may include a CIO determination part 300. The system that is in charge of energy saving policy and control of a base station may include an ES base station operation part 400.

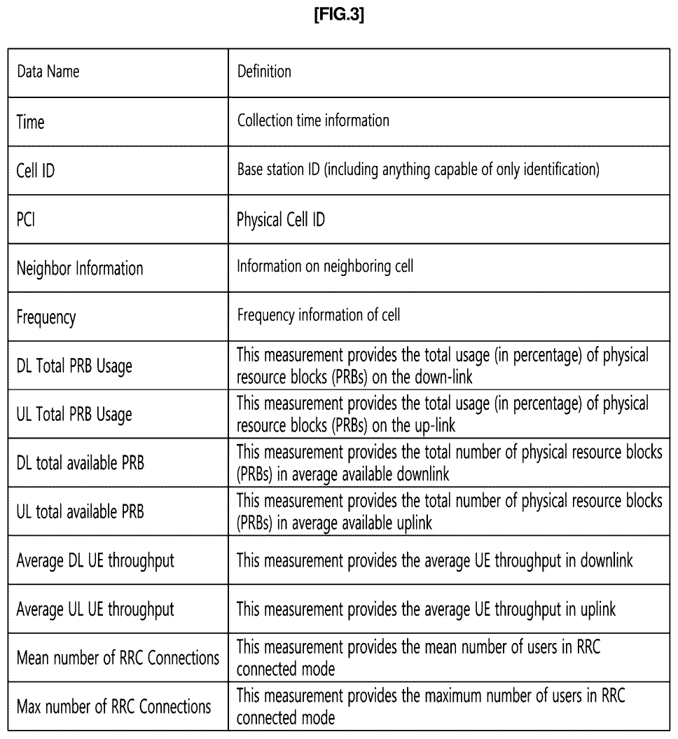

FIG. 3 shows what collects data from a base station related to a SON system and what is collected in a wireless communication system according to various embodiments of the present disclosure. The configuration of FIG. 3 may be combined with various embodiments of the present disclosure.

Referring to FIG. 3, the data collector 100 may have a function of periodically collecting PM data as shown in FIG. 3 from base stations and storing the PM data in a database.

FIG. 3 shows particular PM data, but the present disclosure is not limited thereto. For example, the present disclosure may be application to data other than the particular PM data.

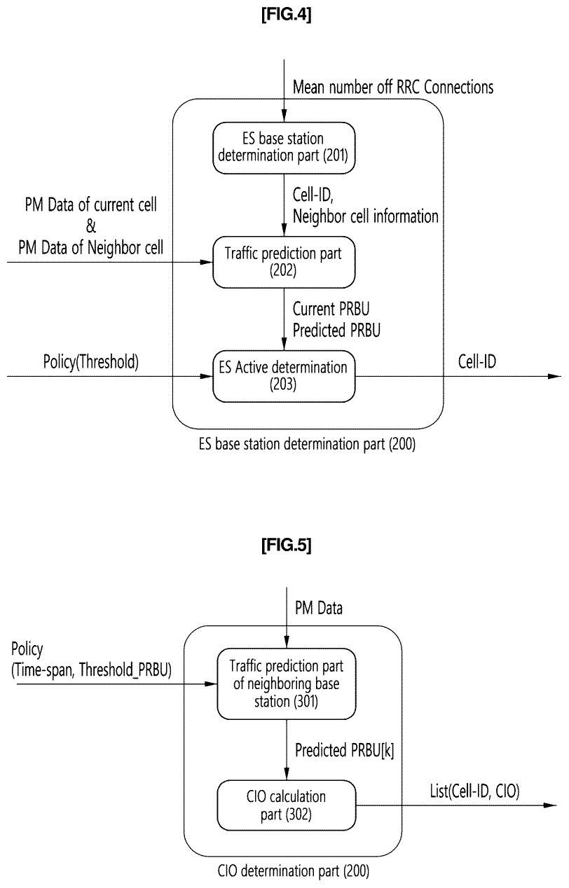

FIG. 4 shows an energy saving base station determination part 200 in a wireless communication system according to various embodiments of the present disclosure. The configuration of FIG. 4 may be combined with various embodiments of the present disclosure.

Referring to FIG. 4, the energy saving (ES) base station determination part 200 may have a function of monitoring a value of the mean number of RRC connections of each base station from a database (DB) and determining an energy saving target base station. The mean numbers of RRC connections may be mean values resulting from collecting the numbers of UEs connected to base stations at regular intervals (seconds or minutes) during a predetermined period of time.

An ES candidate base station determination part 201 of the ES base station determination part 200 may monitor the numbers of UE connections of all base stations, and when the condition as shown in [Equation 1] is satisfied, the ES candidate base station determination part may forward information on a neighboring base station of the base station to a traffic prediction part 202.

$${Counter ( mean numbers of RRC Connections \leq ES Threshold )}_{T} \qquad [ Equation 1 ]$$

In [Equation 1], the mean numbers of RRC connections may be mean values resulting from collecting the numbers of UEs connected to base stations at regular intervals (seconds or minutes) during a predetermined period of time. In [Equation 1], ES Threshold may be a value set by a network operator to determine an energy saving base station. In [Equation 1], T may be the period of monitoring to determine an energy saving base station. For example, when the mean number of UEs connected to a base station is less than a threshold value set by an operator and this occurs continuously for a predetermined period of time (T), it may be determined that the base station is an energy saving target base station.

The traffic prediction part 202 may collect traffic-related data shown in FIG. 3 from its neighboring base stations and may compute a traffic prediction average for the next period of time T using an artificial intelligence model. It may be determined using current traffic physical resource block usage (PRBU) and computed traffic prediction (Predicted PRBU) that an ES candidate base station is an ES target base station when having a value equal to or less than a threshold value given by the policy.

The traffic prediction part 202 may determine an ES Active 203. For example, the traffic prediction part 202 may determine an ES Active 203 through the current traffic PRBU. For example, the traffic prediction part 202 may determine an ES Active 203 through predicted PRBU.

A PRB may be usually associated with one subcarrier group, and may be used for data transmission. The term PRBU may refer to a metric related to the usage ratio or allocation state of the PRB. The PRBU may be interpreted as an indicator of how much a PRB has been used in the network during a particular time period, or how many of available PRBs have actually been allocated. The PRBU may be used to monitor and analyze the resource usage efficiency of the network, the capacity state of a cell, and a traffic load.

The base station information determined by the ES base station determination part 200 may be forwarded to the CIO determination part 300, and the CIO determination part 300 may calculate a parameter value for handover of a user equipment (user) connected to the energy saving target base station to an optimal neighboring base station.

FIG. 5 shows a CIO determination part 300 in a wireless communication system according to various embodiments of the present disclosure. The configuration of FIG. 5 may be combined with various embodiments of the present disclosure.

Referring to FIG. 5, a traffic prediction part 301 of a neighboring base station may predict future physical resource block usage (PRBU) by using a convolution long short term memory (LSTM) model that has spatio-temporal characteristics and uses PM data as shown in FIG. 3 as input. The convolution LSTM may be a type of a recurrent neural network (RNN) designed to process spatio-temporal data. The RNN may combine the spatial structure processing ability of a convolutional neural network (CNN) and the temporal sequential modeling ability of the LSTM network.

Regarding the period of the PRBU that needs to be predicted, according to the policy determined by the ES base station operation part 400, the physical resource block usage (PRBU) value during the period (time-span) when the power of the energy saving target base station is turned off may be predicted and forwarded to a CIO calculation part. Predicted PRBU[k] may be a PRBU value predicted for all neighboring base stations of the energy saving target base station. K may denote the number of base stations.

The CIO calculation part 302 may determine the CIO of the currently neighboring base station by using the current PRBU value and the predicted PRBU value. The CIO determination method may be defined as [Equation 2] below.

$$CIO [ K ] = ⌊ \{ Threshold\_PRBU - \frac{Current\_PRBU [ K ] + Predicted\_PRBU [ K ]}{2} \} / 10 ⌋ \qquad [ Equation 2 ]$$

In [Equation 2], Threshold PRBU may be a PRBU threshold provided to the ES base station operation part. In [Equation 2], Current_PRBU[k] may be the current PRBU of base station K. In [Equation 2], Predicted_PRBU[k] may be the predicted PRBU of base station K.

The calculated CIO of the K-th base station and the base station ID (Cell-ID) of base station K may be managed in a pair and forwarded to the ES base station operation part 400.

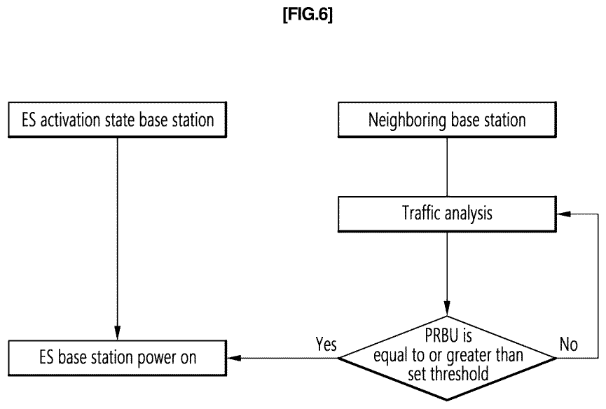

FIG. 6 shows a procedure for deactivating an ES target base station on the basis of a traffic threshold value in a wireless communication system according to various embodiments of the present disclosure. The configuration of FIG. 6 may be combined with various embodiments of the present disclosure.

Referring to FIG. 6, the ES base station operation part 400 may include a function for monitoring the energy saving target base station and controlling the power-off period, and a function for managing a CIO value of a neighboring base station and forwarding a control message to the base station in order to cover the area of the energy saving target base station.

As the policy of the ES base station operation part 400, a power-off value (for example, from the current time to two hours later) defined by a network operator may be input and operated, and the operator may define and operate a traffic threshold value so that the system can make an intelligent decision. The PRBUs of all neighboring base stations of a base station operated with energy saving are periodically monitored, and when a particular base station exceeds a traffic threshold value, the power of the energy saving target base station may be turned on.

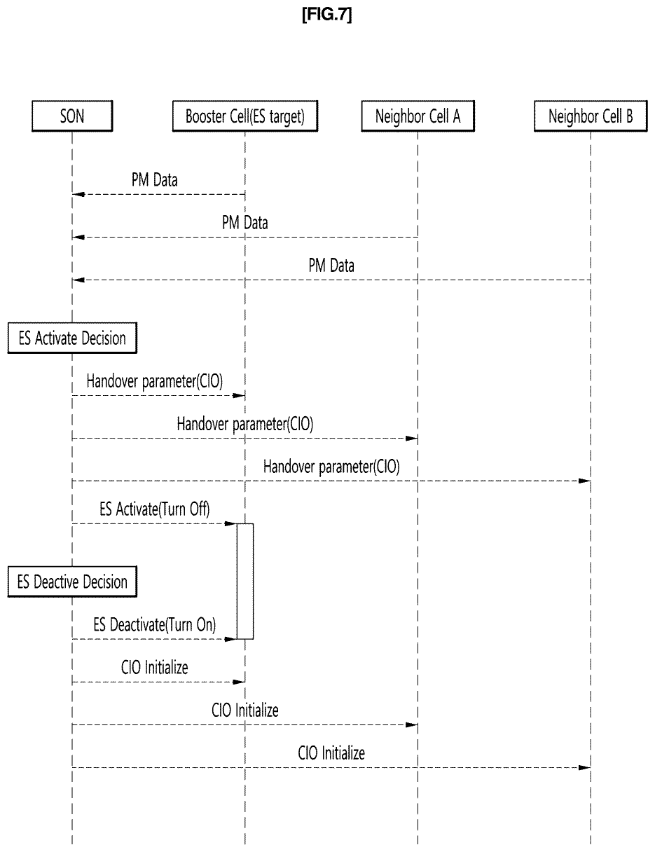

FIG. 7 shows an energy saving operation procedure in a wireless communication system according to various embodiments of the present disclosure. The configuration of FIG. 7 may be combined with various embodiments of the present disclosure.

Referring to FIG. 7, a SON system may periodically collect PM data from base stations and may monitor the data to determine an ES target base station. Once an ES target base station is determined according to the procedure and the function shown in FIG. 2 and the CIO values of the neighboring base stations are determined, the CIO values may be distributed to all involved base stations. When all user equipments are handed over to a neighboring base station, the power of the ES target base station may be turned off. The SON system may monitor data of neighboring base stations, and when traffic increases above a particular threshold, the ES target base station may be activated (for example, power on) again and changed CIO values may be set as initial values.

The present disclosure proposes a method of controlling the power of a base station for energy saving and handing over a user equipment connected to an ES target base station to an optimal neighboring base station through traffic analysis of neighboring base stations.

FIG. 8 shows a method in which an apparatus related to a self-organizing network (SON) performs wireless communication according to an embodiment of the present disclosure. The configuration of FIG. 8 may be combined with various embodiments of the present disclosure.

Referring to FIG. 8, in step S810, an apparatus related to a SON may receive the number of RRC connections from a first base station. In step S820, the apparatus related to the SON may determine whether the number of RRC connects exceeds a threshold value for energy saving. In step S830, on the basis of the fact that the number of RRC connects does not exceed the threshold value, the apparatus related to the SON may obtain information on a second base station neighboring the first base station. In step S840, the apparatus related to the SON may determine an energy saving base station on the basis of current physical resource block usage (PRBU) and predicted PRBU of the second base station.

For example, on the basis of the fact that a PRBU value related to the current PRBU and the predicted PRBU of the second base station is equal to or less than a threshold PRBU value, the power of the energy saving base station may be turned off.

For example, on the basis of the fact that a PRBU value related to the current PRBU and the predicted PRBU of the second base station is greater than the threshold PRBU value, the power of the energy saving base station may be turned on.

For example, the cell individual offset (CIO) of the second base station may be obtained. For example, the CIO of the second base station may be determined on the basis of the current PRBU and the predicted PRBU of the second base station.

For example, the CIO of the second base station may be transmitted to the first base station.

For example, the information on the second base station may be obtained at regular intervals.

For example, the CIO of the second base station may be a parameter used for handover.

For example, the CIO of the second base station may be determined by [Equation] below. For example, [Equation] may be

$$CIO [ K ] = ⌊ \{ Threshold\_PRBU - \frac{Current\_PRBU [ K ] + Predicted\_PRBU [ K ]}{2} \} / 10 ⌋ .$$

For example, in the [Equation], Threshold PRBU may denote the threshold PRBU, Current_PRBU[k] may denote the current PRBU of base station K, and Predicted_PRBU[k] may denote the predicted PRBU of base station K.

For example, on the basis of the fact that handover of the user equipment connected to the first base station is completed, the power of the energy saving base station may be turned off.

For example, on the basis of the fact that the traffic of the second base station reaches a threshold, the power of the energy saving base station may be turned on.

First, a processor of the apparatus related to the SON may enable the number of RRC connections to be received from the first base station. In addition, the processor of the apparatus related to the SON may enable whether the number of RRC connections exceeds a threshold value for energy saving to be determined. In addition, the processor of the apparatus related to the SON may enable information on a second base station neighboring the first base station to be obtained on the basis of the fact that the number of RRC connections does not exceed the threshold value. In addition, the processor of the apparatus related to the SON may enable an energy saving base station to be determined on the basis of current physical resource block usage (PRBU) and predicted PRBU of the second base station. For example, the process of the apparatus related to the SON may be a controller 1130 of the apparatus related to the SON.

According to an embodiment of the present disclosure, there is provided an apparatus related to a SON set to perform wireless communication. For example, the apparatus related to the SON may include at least one transceiver, and at least one processor connected to the at least one transceiver. The at least one processor may enable the apparatus to: receive the number of RRC connections from a first base station; determine whether the number of RRC connections exceeds a threshold value for energy saving; obtain, on the basis of the fact that the number of RRC connections does not exceed the threshold value, information on a second base station neighboring the first base station; and determine an energy saving base station on the basis of current physical resource block usage (PRBU) and predicted PRBU of the second base station.

According to an embodiment of the present disclosure, there is provided a processing apparatus set to control an apparatus related to a SON set to perform wireless communication. For example, the processing apparatus may include at least one processor. The at least one processor may enable the apparatus to: receive the number of RRC connections from a first base station; determine whether the number of RRC connections exceeds a threshold value for energy saving; obtain, on the basis of the fact that the number of RRC connections does not exceed the threshold value, information on a second base station neighboring the first base station; and determine an energy saving base station on the basis of current physical resource block usage (PRBU) and predicted PRBU of the second base station.

According to an embodiment of the present disclosure, there is provided a non-transitory computer-readable storage medium recording instructions thereon. For example, when executed, the instructions may enable an apparatus related to a SON set to perform wireless communication to: receive the number of RRC connections from a first base station; determine whether the number of RRC connections exceeds a threshold value for energy saving; obtain, on the basis of the fact that the number of RRC connections does not exceed the threshold value, information on a second base station neighboring the first base station; and determine an energy saving base station on the basis of current physical resource block usage (PRBU) and predicted PRBU of the second base station.

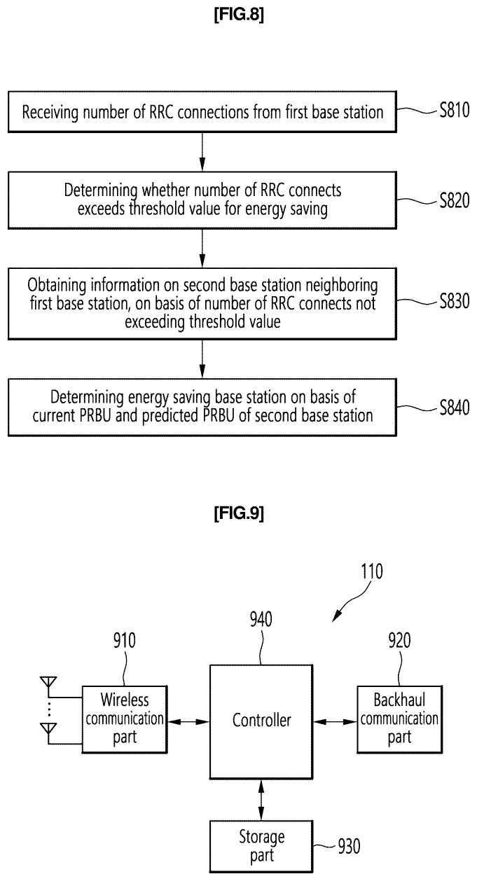

FIG. 9 shows a configuration diagram of a base station in a wireless communication system according to various embodiments of the present disclosure. The configuration illustrated in FIG. 9 may be understood as a configuration of a base station 110. The terms “˜ part”, “˜ unit”, and the like used below mean a unit for processing at least one function or operation, and may be implemented by hardware, software, or a combination of hardware and software. The configuration of FIG. 9 may be combined with various embodiments of the present disclosure.

Referring to FIG. 9, the base station 110 may include a wireless communication part 910, a backhaul communication part 920, a storage part 930, and a controller 940.

The wireless communication part 910 may transmit and receive wireless signals through a wireless channel. For example, the wireless communication part 910 may perform a function of conversion between a baseband signal and a bit string according to the physical layer standards of a system. In addition, when transmitting data, the wireless communication part 910 may generate complex symbols by encoding and modulating a transmission bit string. When receiving data, the wireless communication part 910 may restore a reception bit string by demodulating and decoding a baseband signal.

In addition, the wireless communication part 910 may up-convert a baseband signal into a radio frequency (RF) band signal and transmit the RF band signal through an antenna, and may down-convert an RF band signal received through an antenna into a baseband signal. To this end, the wireless communication part 910 may include a transmission filter, a reception filter, an amplifier, a mixer, an oscillator, a digital-to-analog converter (DAC), and an analog-to-digital converter (ADC).

The wireless communication part 910 may include multiple transmission and reception paths. The wireless communication part 910 may include at least one antenna array composed of multiple antenna elements.

In terms of hardware, the wireless communication part 910 may include a digital unit and an analog unit. The analog unit may include multiple sub-units according to operating power or operating frequency. The digital unit may be realized as at least one processor (e.g., digital signal processor (DSP)).

The wireless communication part 910 may transmit and receive wireless signals as described above. Accordingly, all or part of the wireless communication part 910 may be referred to as a “transmitter”, “receiver”, or “transceiver”. In addition, in the following description, transmission and reception performed through a wireless channel may include the above-described processing performed by the wireless communication part 910.

The backhaul communication part 920 may provide an interface for performing communication with other nodes in the network. That is, the backhaul communication part 920 may convert bit strings transmitted from the base station to other nodes, such as other access nodes, other base stations, a parent node, and a core network, into physical signals, and may convert physical signals received from other nodes into bit strings.

The storage part 930 may store therein data, such as default programs, application programs, and setting information for the operation of the base station. The storage part 930 may be a volatile memory, a non-volatile memory, or a combination of a volatile memory and a non-volatile memory. In addition, the storage part 930 may provide stored data according to a request of the controller 940.

The controller 940 may control overall operations of the base station. For example, the controller 940 may transmit and receive signals through the wireless communication part 910 or the backhaul communication part 920. In addition, the controller 940 may record data on the storage part 930 and may read the data. In addition, the controller 940 may perform functions of a protocol stack that communication standards require.

To this end, the controller 940 may include at least one processor.

According to various embodiments of the present disclosure, the controller 940 may perform control so that the base station performs the operations according to various embodiments.

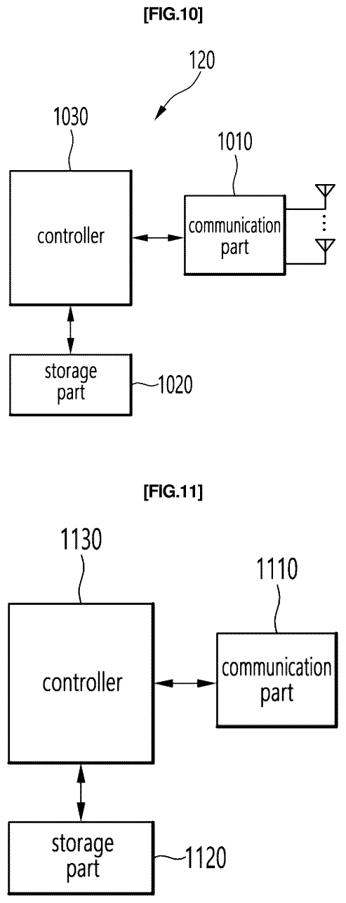

FIG. 10 shows a configuration diagram of a user equipment in a wireless communication system according to various embodiments of the present disclosure. The configuration illustrated in FIG. 10 may be understood as a configuration of a user equipment 120. The terms “˜ part”, “˜ unit”, and the like used below mean a unit for processing at least one function or operation, and may be implemented by hardware, software, or a combination of hardware and software. The configuration of FIG. 10 may be combined with various embodiments of the present disclosure.

Referring to FIG. 10, the user equipment may include a communication part 1010, a storage part 1020, and a controller 1030.

The communication part 1010 may perform functions for transmitting and receiving signals through a wireless channel. For example, the communication part 1010 may perform a function of conversion between a baseband signal and a bit string according to the physical layer standards of a system. For example, when transmitting data, the communication part 1010 may generate complex symbols by encoding and modulating a transmission bit string. When receiving data, the communication part 1010 may restore a reception bit string by demodulating and decoding a baseband signal. In addition, the communication part 1010 may up-convert a baseband signal into an RF band signal and transmit the RF band signal through an antenna, and may down-convert an RF band signal received through an antenna a baseband signal. For example, the communication part 1010 may transmission filter, a reception filter, an amplifier, a mixer, an oscillator, a DAC, and an ADC.

In addition, the communication part 1010 may include multiple transmission and reception paths. Furthermore, the communication part 1010 may include at least one antenna array composed of multiple antenna elements. In terms of hardware, the communication part 1010 may be a digital circuit and an analog circuit (for example, a radio frequency integrated circuit (RFIC)). Herein, the digital circuit and the analog circuit may be realized as one package. In addition, the communication part 1010 may include multiple RF chains. Furthermore, the communication part 1010 may perform beamforming.

The communication part 1010 transmits and receives signals as described above. Accordingly, all or part of the communication part 1010 may be referred to as a “transmitter”, “receiver”, or “transceiver”. In addition, in the following description, transmission and reception performed through a wireless channel may be used to mean that the communication part 1010 performs the above-described processing.

The storage part 1020 may store therein data, such as default programs, application programs, and setting information for the operation of the user equipment. The storage part 1020 may be a volatile memory, a non-volatile memory, or a combination of a volatile memory and a non-volatile memory. In addition, the storage part 1020 may provide stored data according to a request of the controller 1030.

The controller 1030 may control overall operations of the user equipment. For example, the controller 1030 may transmit and receive signals through the communication part 1010. In addition, the controller 1030 may record data on the storage part 1020 and may read the data. The controller 1030 may perform functions of a protocol stack that communication standards require. To this end, the controller 1030 may include at least one processor or microprocessor, or may be part of a processor. In addition, part of the communication part 1010 and the controller 1030 may be referred to as a communication processor (CP).

According to various embodiments, the controller 1030 may perform control so that the user equipment performs the operations according to the various embodiments.

FIG. 11 shows a configuration diagram of a SON system in a wireless communication system according to various embodiments of the present disclosure. The configuration illustrated in FIG. 11 may be understood as a configuration of a SON system. The terms “˜ part”, “˜ unit”, and the like used below mean a unit for processing at least one function or operation, and may be implemented by hardware, software, or a combination of hardware and software. The configuration of FIG. 11 may be combined with various embodiments of the present disclosure.

Referring to FIG. 11, an apparatus related to a SON may include a communication part 1110, a storage part 1120, and a controller 1130.

The communication part 1110 may perform functions for transmitting and receiving signals through a wireless channel. For example, the communication part 1110 may perform a function of conversion between a baseband signal and a bit string according to the physical layer standards of a system. For example, when transmitting data, the communication part 1110 may generate complex symbols by encoding and modulating a transmission bit string. When receiving data, the communication part 1110 may restore a reception bit string by demodulating and decoding a baseband signal. In addition, the communication part 1110 may up-convert a baseband signal into an RF band signal and transmit the RF band signal through an antenna, and may down-convert an RF band signal received through an antenna into a baseband signal. For example, the communication part 1110: include a transmission filter, a reception filter, an amplifier, a mixer, an oscillator, a DAC, and an ADC.

In addition, the communication part 1110 may include multiple transmission and reception paths. Furthermore, the communication part 1110 may include at least one antenna array composed of multiple antenna elements. In terms of hardware, the communication part 1110 may be a digital circuit and an analog circuit (for example, a radio frequency integrated circuit (RFIC)). Herein, the digital circuit and the analog circuit may be realized as one package. In addition, the communication part 1110 may include multiple RF chains. Furthermore, the communication part 1110 may perform beamforming.

The communication part 1110 transmits and receives signals as described above. Accordingly, all or part of the communication part 1110 may be referred to as a “transmitter”, “receiver”, or “transceiver”. In addition, in the following description, transmission and reception performed through a wireless channel may be used to mean that the communication part 1110 performs the above-described processing.

The storage part 1120 may store therein data, such as default programs, application programs, and setting information for the operation of the apparatus related to the SON. The storage part 1120 may be a volatile memory, a non-volatile memory, or a combination of a volatile memory and a non-volatile memory. In addition, the storage part 1120 may provide stored data according to a request of the controller 1130.

The controller 1130 may control overall operations of the apparatus related to the SON. For example, the controller 1130 may transmit and receive signals through the communication part 1110. In addition, the controller 1130 may record data on the storage part 1120 and may read the data. The controller 1130 may perform functions of a protocol stack that communication standards require. To this end, the controller 1130 may include at least one processor or microprocessor, or may be part of a processor. In addition, part of the communication part 1110 and the controller 1130 may be referred to as a communication processor (CP).

According to various embodiments, the controller 1130 may perform control so that the apparatus related to the SON performs the operations according to the various embodiments.

Methods according to the embodiments described in the claims of the present disclosure or in the specification may be implemented in the form of hardware, software, or a combination of hardware and software.

In the case of software implementation, a computer-readable storage medium in which at least one program (software module) is stored may be provided. The at least one program stored in the computer-readable storage medium is configured to be executable by at least one processor in an electronic device. The at least one program includes instructions for the electronic device to execute the methods according to the embodiments described in the claims of the present disclosure or the specification.

The program (software module or software) may be stored in non-volatile memory including random-access memory and flash memory, read-only memory (ROM), electrically erasable programmable read-only memory (EEPROM), a magnetic disc storage device, a compact disc-ROM (CD-ROM), digital versatile discs (DVDs), optical storage devices of other types, or a magnetic cassette. Alternatively, the program may be stored in a memory composed of a combination of some or all of these memories. In addition, a plurality of such memories may be included.

In addition, the program may be stored in an attachable storage device that is accessible through a communication network, such as the Internet, Intranet, a local area network (LAN), a wide area network (WAN), or a storage area network (SAN), or a combination thereof. The storage device may be connected through an external port to an apparatus performing an embodiment of the present disclosure. In addition, a separate storage device on the communication network may be connected to the apparatus performing an embodiment of the present disclosure.

In the above-described detailed embodiments of the disclosure, an element included in the disclosure is expressed in the singular or the plural according to a presented detailed embodiment. However, the singular form or plural form is selected suitable for the presented situation for convenience of description, and the various embodiments of the disclosure are not limited to a single element or multiple elements thereof. Further, multiple elements expressed in the description may be configured into a single element or a single element in the description may be configured into multiple elements.

Although the specific embodiments have been described in the detailed description of the present disclosure, various modifications and changes may be made thereto without departing from the scope of the present disclosure. Therefore, the scope of the present disclosure should not be defined as being limited to the embodiments, but should be defined by the appended claims and equivalents thereof.

What is claimed is:

1. A method performed by an apparatus related to a self-organizing network (SON) in a wireless communication system, the method comprising:
receiving the number of RRC connections from a first base station;
determining whether the number of RRC connections exceeds a threshold value for energy saving;
obtaining, on the basis of the fact that the number of RRC connections does not exceed the threshold value, information on a second base station neighboring the first base station; and
determining an energy saving base station on the basis of current physical resource block usage (PRBU) and predicted PRBU of the second base station.

2. The method of claim 1, wherein on the basis of the fact that a PRBU value related to the current PRBU and the predicted PRBU of the second base station is equal to or less than a threshold PRBU value, power of the energy saving base station is turned off.

3. The method of claim 1, wherein on the basis of the fact that a PRBU value related to the current PRBU and the predicted PRBU of the second base station is greater than a threshold PRBU value, power of the energy saving base station is turned on.

4. The method of claim 1, wherein cell individual offset (CIO) of the second base station is obtained, and
the CIO of the second base station is determined on the basis of the current PRBU and the predicted PRBU of the second base station.

5. The method of claim 4, wherein the CIO of the second base station is transmitted to the first base station.

6. The method of claim 1, wherein the information on the second base station is obtained at regular intervals.

7. The method of claim 4, wherein the CIO of the second base station is a parameter used for handover.

8. The method of claim 4, wherein the CIO of the second base station is determined by [Equation] below,
$$CIO [ K ] = ⌊ \{ Threshold\_PRBU - \frac{Current\_PRBU [ K ] + Predicted\_PRBU [ K ]}{2} \} / 10 ⌋ \qquad [ Equation ]$$
in the [Equation], Threshold PRBU denotes threshold PRBU, Current_PRBU[k] denotes current PRBU of base station K, and Predicted_PRBU[k] denotes predicted PRBU of base station K.

9. The method of claim 1, wherein on the basis of the fact that handover of a user equipment connected to the first base station is completed, power of the energy saving base station is turned off.

10. The method of claim 9, wherein on the basis of the fact that traffic of the second base station reaches a threshold, the power of the energy saving base station is turned on.

11. An apparatus related to a self-organizing network (SON) in a wireless communication system, the apparatus comprising:
at least one transceiver; and
at least one processor connected to the at least one transceiver,
wherein the at least one processor is configured to enable the apparatus to:
receive the number of RRC connections from a first base station;
determine whether the number of RRC connections exceeds a threshold value for energy saving;
obtain, on the basis of the fact that the number of RRC connections does not exceed the threshold value, information on a second base station neighboring the first base station; and
determine an energy saving base station on the basis of current physical resource block usage (PRBU) and predicted PRBU of the second base station.

12. The apparatus of claim 11, wherein on the basis of the fact that a PRBU value related to the current PRBU and the predicted PRBU of the second base station is equal to or less than a threshold PRBU value, power of the energy saving base station is turned off.

13. The apparatus of claim 11, wherein on the basis of the fact that a PRBU value related to the current PRBU and the predicted PRBU of the second base station is greater than a threshold PRBU value, power of the energy saving base station is turned on.

14. The apparatus of claim 11, wherein cell individual offset (CIO) of the second base station is obtained, and
the CIO of the second base station is determined on the basis of the current PRBU and the predicted PRBU of the second base station.

15. The apparatus of claim 14, wherein the CIO of the second base station is transmitted to the first base station.

16. The apparatus of claim 11, wherein the information on the second base station is obtained at regular intervals.

17. The apparatus of claim 14, wherein the CIO of the second base station is a parameter used for handover.

18. The apparatus of claim 14, wherein the CIO of the second base station is determined by [Equation] below,
$$CIO [ K ] = ⌊ \{ Threshold\_PRBU - \frac{Current\_PRBU [ K ] + Predicted\_PRBU [ K ]}{2} \} / 10 ⌋ \qquad [ Equation ]$$
in the [Equation], Threshold PRBU denotes threshold PRBU, Current_PRBU[k] denotes current PRBU of base station K, and Predicted_PRBU[k] denotes predicted PRBU of base station K.

19. The apparatus of claim 11, wherein on the basis of the fact that handover of a user equipment connected to the first base station is completed, power of the energy saving base station is turned off.

20. The apparatus of claim 19, wherein on the basis of the fact that traffic of the second base station reaches a threshold, the power of the energy saving base station is turned on.
